(19) United States
(12) Patent Application Publication
(10) Pub. No.: US 2015/0221112 A1
(43) Pub. Date: Aug. 6, 2015

(54) Emotion Indicators in Content

(71) Applicant: Microsoft Corporation, Redmond, WA (US)

(72) Inventors: Rishi Mallik, Chino Hills, CA (US); Bhaskar Roy, Los Altos, CA (US); Joel Soderberg, Edmonds, WA (US); Antonio Pedro Pernambuco Rezende, London (GB); Hava Marie Kagle, Mountain View, CA (US); Charles Goran, Morgan Hill, CA (US)

(73) Assignee: Microsoft Corporation, Redmond, WA (US)

(21) Appl. No.: 14/172,738

(22) Filed: Feb. 4, 2014

(51) Int. Cl. G06T 11/60; G06F 3/0482; G06F 3/0481; G06F 3/0484

(52) U.S. Cl. CPC G06T 11/60; G06F 3/04842; G06F 3/0482; G06F 3/04817; G06T 2207/20221

(57) ABSTRACT

Various embodiments enable visual representations associated with one or more emotions to be associated with content, such as videos or photos. A visual representation serves as a reference point to a particular content segment and conveys an emotion associated with the content segment. The visual representations can be created and associated with content by a number of different entities including, by way of example and not limitation, content producers and content consumers.

### BACKGROUND

The ability to share content, particularly with one's friends, has flourished with the growth in popularity of the Internet. Content-sharing opportunities have further been created with the advent of social networking sites where, for example, a user may post videos or photos to share with others. With the increasing popularity of content sharing, efforts continue on the part of those in the industry to enhance the user's experience and ability to share their content and consume the content of others.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments enable visual representations associated with one or more emotions to be associated with content, such as videos or photos. A visual representation serves as a reference point to a particular content segment and conveys an emotion associated with the content segment. The visual representations can be created and associated with content by a number of different entities including, by way of example and not limitation, content producers and content consumers.

In at least some embodiments, the visual representations can be used to generate thumbnail images of the content, where a thumbnail image corresponds to a content segment with which a visual representation has been associated.

In yet further embodiments, the visual representations can be used to create a content summary. For example, content that has a number of different visual representations associated therewith, can be processed to produce a content summary that includes content segments associated with each of the visual representations.

Further, in at least some embodiments, the visual representations can include information such as who created the visual representation, as well as other information such as comments and the like. In addition, visual representations can be used to facilitate navigation to a particular content segment having an associated visual representation.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation in accordance with one or more embodiments.

FIG. 2 is an illustration of a system in an example implementation showing FIG. 1 in greater detail.

FIG. 3 illustrates an example environment in accordance with one or more embodiments.

FIG. 4 illustrates an example user interface in accordance with one or more embodiments.

FIG. 5 illustrates an example camera in accordance with one or more embodiments.

FIG. 6 is a flow diagram that describes steps in a method in accordance with one or more embodiments.

FIG. 7 illustrates an example user interface in accordance with one or more embodiments.

FIG. 8 is a flow diagram that describes steps in a method in accordance with one or more embodiments.

FIG. 9 illustrates an example user interface in accordance with one or more embodiments.

FIG. 10 is a flow diagram that describes steps in a method in accordance with one or more embodiments.

FIG. 11 illustrates an example user interface in accordance with one or more embodiments.

FIG. 12 is a flow diagram that describes steps in a method in accordance with one or more embodiments.

FIG. 13 illustrates an example user interface in accordance with one or more embodiments.

FIG. 14 is a flow diagram that describes steps in a method in accordance with one or more embodiments.

FIG. 15 illustrates an example user interface in accordance with one or more embodiments.

FIG. 16 illustrates an example computing device that can be utilized to implement various embodiments described herein.

### DETAILED DESCRIPTION

### Overview

Various embodiments enable visual representations associated with one or more emotions to be associated with content, such as videos or photos. A visual representation serves as a reference point to a particular content segment and conveys an emotion associated with the content segment, thus serving a dual role. In this sense, visual representations serve as ideograms or ideographs that can represent emotions such as like, dislike, love, hate, etc., associated with content. As such, the visual representations are different from and are not to be confused with bookmarks. Bookmarks typically do not convey any emotion and simply serve as a way of marking a place in a particular piece of content. When content with the visual representations is shared amongst various users, the visual representations convey emotion to those who consume the content. In social networking settings, the visual representations can serve to facilitate a viral quality to publish content.

The visual representations can be created and associated with content by a number of different entities including, by way of example and not limitation, content producers and content consumers, thus serving to improve the user experience and establish a richer media environment for shared content. For example, a content producer may be creating a video using their mobile device or camera. While creating the video, the content producer may select an associated user interface element to insert a visual representation in a particular content segment. Alternately or additionally, content consumers such as content viewers, can create their own visual representations and have those visual representations associated with content segments. For example, as a content consumer views a particular video, they can select a suitable user interface element to insert a visual representation in a particular content segment.

In at least some embodiments, the visual representations can be used to generate thumbnail images of the content, where a thumbnail image corresponds to a content segment with which a visual representation has been associated. In this manner, the thumbnail images can serve as advertisements for content when it is distributed. For example, the thumbnail images can identify meaningful segments of content so that others to whom the content is distributed can quickly ascertain one or more content segments that may be of interest.

In yet further embodiments, the visual representations can be used to create a content summary. For example, content that has a number of different visual representations associated therewith, can be processed to produce a content summary that includes content segments associated with each of the visual representations. In this manner, others to whom the content is distributed can have an encapsulated view of those content segments that have an associated visual representation.

Further, in at least some embodiments, the visual representations can include information such as who created the visual representation, as well as other information such as comments and the like. In addition, visual representations can be used to facilitate navigation to a particular content segment having an associated visual representation. For example, in at least some embodiments, when content, such as a video is consumed, a timeline can be presented with associated visual representations at locations along a timeline. By selecting a particular visual representation, a navigation can take place to the corresponding content segment.

In the following discussion, an example environment is first described that is operable to employ the techniques described herein. The techniques may be employed in the example environment, as well as in other environments.

### Example Environment

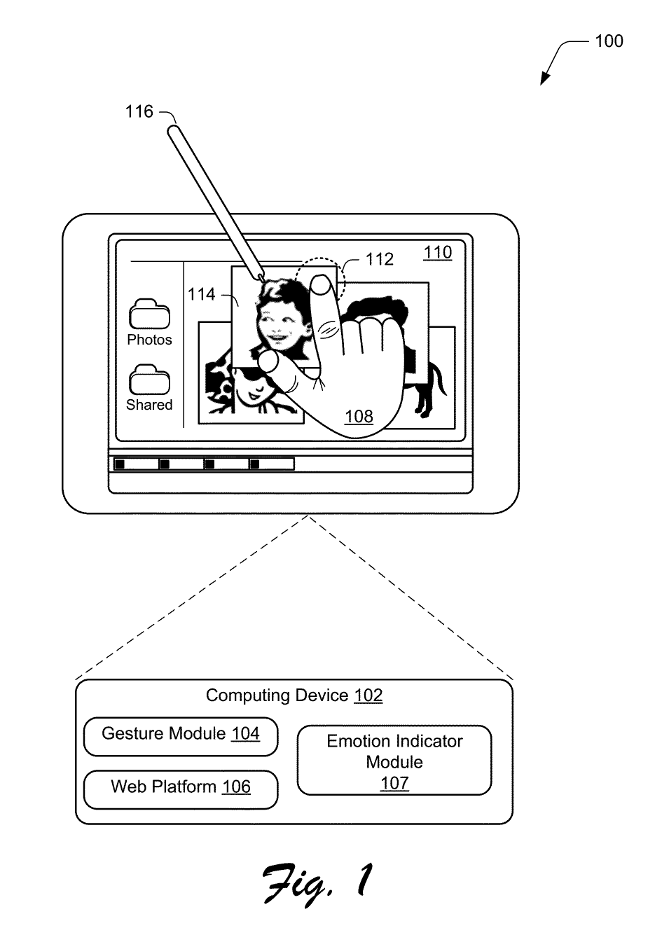

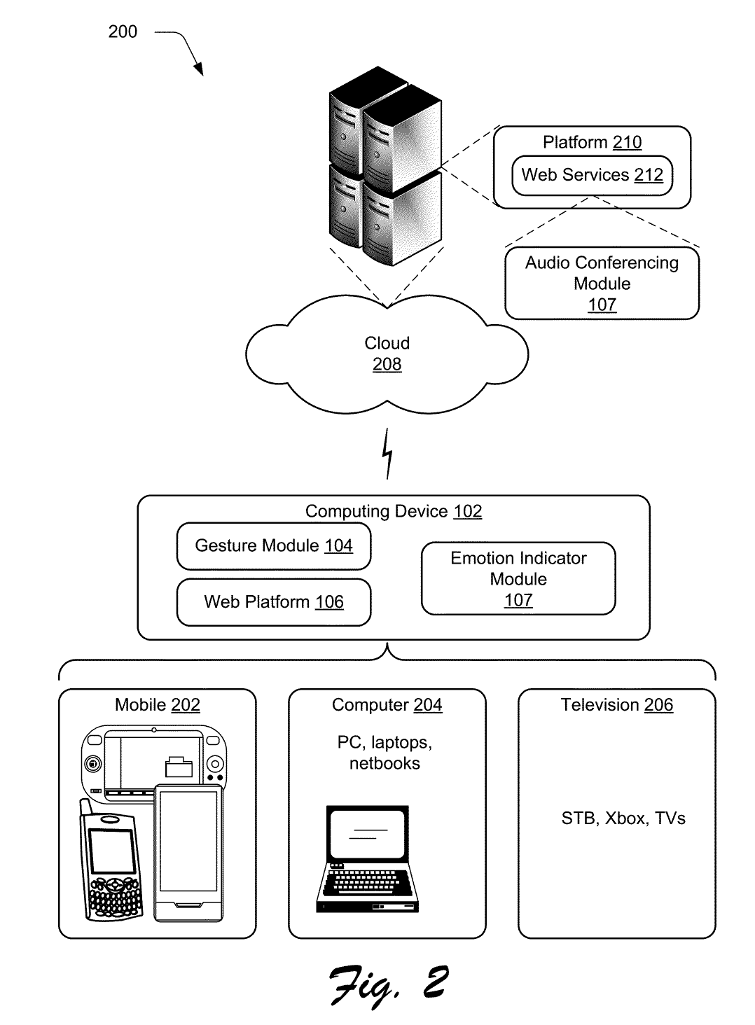

FIG. 1 is an illustration of an environment 100 in an example implementation that is operable to employ the techniques as described herein. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth as further described in relation to FIG. 2. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 also includes software that causes the computing device 102 to perform one or more operations as described below.

Computing device 102 includes a number of modules including, by way of example and not limitation, a gesture module 104, a web platform 106, and an emotion indicator module 107.

The gesture module 104 is operational to provide gesture functionality as described in this document. The gesture module 104 can be implemented in connection with any suitable type of hardware, software, firmware or combination thereof. In at least some embodiments, the gesture module 104 is implemented in software that resides on some type of computer-readable storage medium, examples of which are provided below.

Gesture module 104 is representative of functionality that recognizes gestures that can be performed by one or more fingers, and causes operations to be performed that correspond to the gestures. The gestures may be recognized by module 104 in a variety of different ways. For example, the gesture module 104 may be configured to recognize a touch input, such as a finger of a user's hand 108 as proximal to display device 110 of the computing device 102 using touchscreen functionality. For example, a finger of the user's hand 108 is illustrated as selecting 112 an image 114 displayed by the display device 110.

It is to be appreciated and understood that a variety of different types of gestures may be recognized by the gesture module 104 including, by way of example and not limitation, gestures that are recognized from a single type of input (e.g., touch gestures such as the previously described drag-and-drop gesture) as well as gestures involving multiple types of inputs. For example, module 104 can be utilized to recognize single-finger gestures and bezel gestures, multiple-finger/same-hand gestures and bezel gestures, and/or multiple-finger/different-hand gestures and bezel gestures.

For example, the computing device 102 may be configured to detect and differentiate between a touch input (e.g., provided by one or more fingers of the user's hand 108) and a stylus input (e.g., provided by a stylus 116). The differentiation may be performed in a variety of ways, such as by detecting an amount of the display device 110 that is contacted by the finger of the user's hand 108 versus an amount of the display device 110 that is contacted by the stylus 116.

Thus, the gesture module 104 may support a variety of different gesture techniques through recognition and leverage of a division between stylus and touch inputs, as well as different types of touch inputs.

The web platform 106 is a platform that works in connection with content of the web, e.g. public content. A web platform 106 can include and make use of many different types of technologies such as, by way of example and not limitation, URLs, HTTP, REST, HTML, CSS, JavaScript, DOM, and the like. The web platform 106 can also work with a variety of data formats such as XML, JSON, and the like. Web platform 106 can include various web browsers, web applications (i.e. “web apps”), and the like. When executed, the web platform 106 allows the computing device to retrieve web content such as electronic documents in the form of webpages (or other forms of electronic documents, such as a document file, XML file, PDF file, XLS file, etc.) from a Web server and display them on the display device 110. It should be noted that computing device 102 could be any computing device that is capable of displaying Web pages/documents and connect to the Internet.

Emotion indicator module 107 is representative of functionality that enables visual representations that are associated with one or more emotions to be created, associated with content such as videos or photos, and used while viewing content to enhance a user's experience. A visual representation serves as a reference point to a particular content segment and conveys an emotion associated with the content segment. The visual representations can be created and associated with content by a number of different entities including, by way of example and not limitation, content producers and content consumers. So, in the case of content producers, the emotion indicator module 107 may work in concert with image capturing hardware and software to inject visual representations into content that is captured by the computing device 102. In the case of content consumers, as an individual consumes content using a content consuming application, such as a media player or an application on a social networking site, emotion indicator module 107 can enable the content consumer to inject one or more visual representations into the content, as well as other information such as comments and the like.

The emotion indicator module 107 can include various other functionality as well. For example, in at least some embodiments, the visual representations can be used to generate thumbnail images of the content, where a thumbnail image corresponds to a content segment with which a visual representation has been associated. In yet further embodiments, the visual representations can be used to create a content summary. For example, content that has a number of different visual representations associated therewith, can be processed to produce a content summary that includes content segments associated with each of the visual representations. Further, in at least some embodiments, the visual representations can include information such as who created the visual representation, as well as other information such as comments and the like. In addition, visual representations can be used to facilitate navigation to a particular content segment having an associated visual representation.

FIG. 2 illustrates an example system showing the components of FIG. 1, e.g., emotion indicator module 107, as being implemented in an environment where multiple devices can be interconnected through a central computing device. Aspects of the emotion indicator module 107 can be implemented in a distributed manner. For example, certain aspects of the emotion indicator module 107 can be implemented on a computing device 102, such as a client computing device. Yet other aspects of the emotion indicator module 107 can be implemented by a remote server to provide, in at least some instances, a web service or so-called “cloud” service, as will be described below in more detail.

The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described, the computing device 102 may be configured in a variety of different ways, such as for mobile 202, computer 204, and television 206 uses. At least some of the devices in each of these configurations have a generally corresponding screen size and thus the computing device 102 may be configured as one of these device classes in this example system 200. For instance, the computing device 102 may assume the mobile 202 class of device which includes mobile telephones, music players, game devices, cameras, and so on. The computing device 102 may also assume a computer 204 class of device that includes personal computers, laptop computers, netbooks, tablets, and so on. The television 206 configuration includes configurations of device that involve display in a casual environment, e.g., televisions, set-top boxes, game consoles, and so on. The computing devices may have cameras integrated therein. Thus, the techniques described herein may be supported by these various configurations of the computing device 102 and are not limited to the specific examples described in the following sections.

Cloud 208 is illustrated as including a platform 210 for web services 212. The platform 210 abstracts underlying functionality of hardware (e.g., servers) and software resources of the cloud 208 and thus may act as a “cloud operating system.” For example, the platform 210 may abstract resources to connect the computing device 102 with other computing devices. The platform 210 may also serve to abstract scaling of resources to provide a corresponding level of scale to encountered demand for the web services 212 that are implemented via the platform 210. A variety of other examples are also contemplated, such as load balancing of servers in a server farm, protection against malicious parties (e.g., spam, viruses, and other malware), and so on.

Thus, the cloud 208 is included as a part of the strategy that pertains to software and hardware resources that are made available to the computing device 102 via the Internet or other networks. For example, aspects of the emotion indicator module 107 may be implemented in part on the computing device 102, as well as via platform 210 that supports web services 212. For example, the web service 212 can include social networking functionality that enables various users to share content amongst themselves. When used in connection with the social networking functionality, emotion indicator module 107 can allow individual content producers and content consumers to inject visual representations into content that is shared with others, thus providing an interactive and rich user experience.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features of the audio conferencing techniques described below can be platform-independent, meaning that the techniques may be implemented on a variety of commercial computing platforms having a variety of processors.

For example, the computing device may also include an entity (e.g., software) that causes hardware or virtual machines of the computing device to perform operations, e.g., processors, functional blocks, and so on. For example, the computing device may include a computer-readable medium that may be configured to maintain instructions that cause the computing device, and more particularly the operating system and associated hardware of the computing device to perform operations. Thus, the instructions function to configure the operating system and associated hardware to perform the operations and in this way result in transformation of the operating system and associated hardware to perform functions. The instructions may be provided by the computer-readable medium to the computing device through a variety of different configurations.

One such configuration of a computer-readable medium is a signal bearing medium and thus is configured to transmit the instructions (e.g., as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

In the discussion that follows, a section entitled “Example System” describes an example system in accordance with one or more embodiments. Next, a section entitled “Example Visual Representation” describes visual representations in accordance with one or more embodiments. Following this, a section entitled “Visual Representations Provided by Content Producers” describes various embodiments in which visual representations can be created and embedded in content by those who produce the content. Next, a section entitled “Visual Representations Provided by Content Consumers” describes various embodiments in which visual representations can be provided by those who consume content. Following this, a section entitled “Viewing Visual Representations and Who Has Provided Them” describes user interface aspects of how visual representations can be presented to a content consumer. Next, a section entitled “Auto Summary” describes how visual representations can be utilized to create an automatic summary of content. Following this, a section entitled “Intelligent Thumbnails” describes how visual representations can be utilized to create thumbnail images associated with content. Next, a section entitled “Animation” describes aspects of how visual representations can be presented in connection with various types of animation. Last, a section entitled “Example Device” describes aspects of an example device that can be utilized to implement one or more embodiments.

Consider now a discussion of an example system in accordance with one or more embodiments.

### Example System

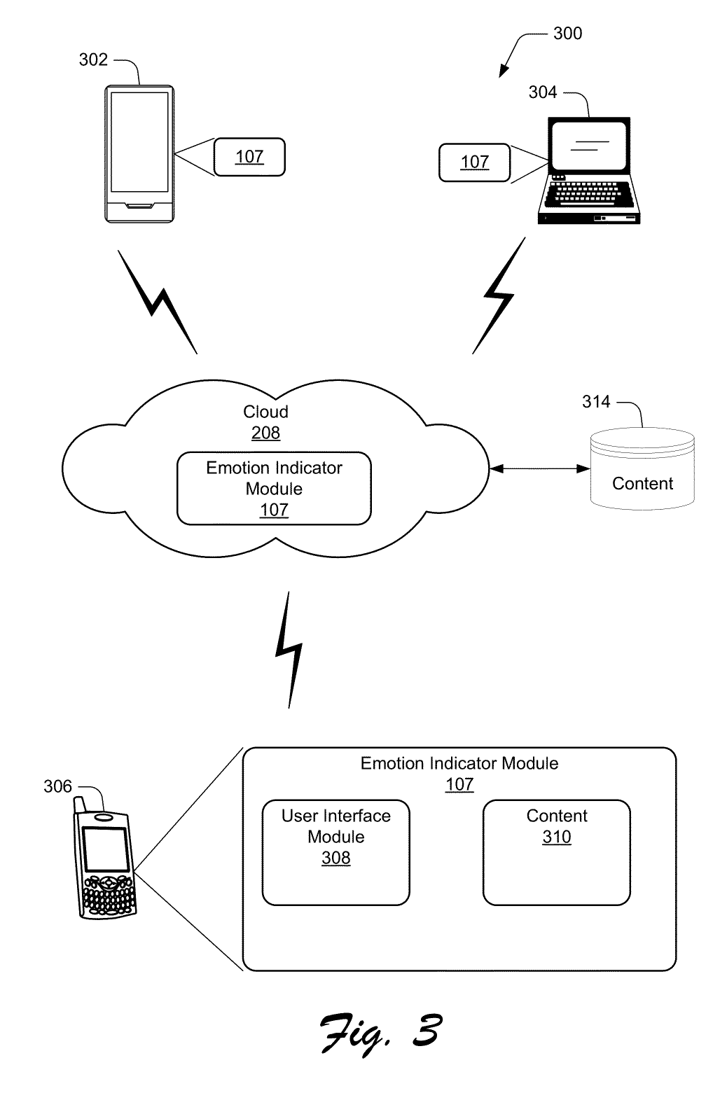

FIG. 3 illustrates an example system in accordance with one or more embodiments generally at 300. In the example about to be described, system 300 enables content to be shared amongst and between multiple different users. This content can include various visual representations as described above and below. The visual representations can be added by a content producer as well as various content consumers.

In this example, system 300 includes devices 302, 304, and 306. Each of devices 302, 304, and 306 can include a camera to enable content to be captured. Such content can include, by way of example and not limitation, still images such as photos, as well as video. Each of the devices is or can be communicatively coupled with one another by way of a network, here cloud 208, e.g., the Internet. In this particular example, each device includes an emotion indicator module 107 which includes functionality as described above and below. In addition, as noted above, aspects of the emotion indicator module 107 can be implemented by cloud 208 or in a cloud service. As such, the functionality provided by the emotion indicator modules can be distributed among the various devices 302, 304, and/or 306. Alternately or additionally, the functionality provided by the emotion indicator modules can be distributed among the various devices and one or more services accessed by way of cloud 208. In at least some embodiments, the emotion indicator module 107 can make use of a suitably-configured database 314 which stores information, such as content that can be shared amongst the various devices, as will become apparent below.

In this particular example, the emotion indicator modules 107 resident on devices 302, 304, and 306 can include or otherwise make use of a user interface module 308 and content 310.

User interface module 308 is representative of functionality that enables the user to interact with content as described above and below. For example, in at least some embodiments the user interface module 308 can be used to enable a content producer to inject one or more visual representations into content that they are producing. Thus, an individual who might be taking a particular video can select a user interface element to add a visual representation as the content is captured. In other embodiments, the user interface module 308 can enable a content consumer to inject a visual representation into content that they consume. For example, assume that a user receives a video from a friend. As they view the video, they can engage a suitably-configured user interface element provided by user interface module 308 to inject a visual representation into the content. Any suitable user interface can be provided by user interface module 308.

Content 310 is representative of content that resides on an end-user's device or is otherwise obtained by the device from, for example, cloud 208. The content 310 can include any suitable type of content including, by way of example and not limitation, captured images such as photos, as well as videos. This content can be processed by the emotion indicator module 107 as described above and below.

Before describing the various inventive embodiments, consider now a discussion of an example visual representation that can be used and added to content.

### Example Visual Representation

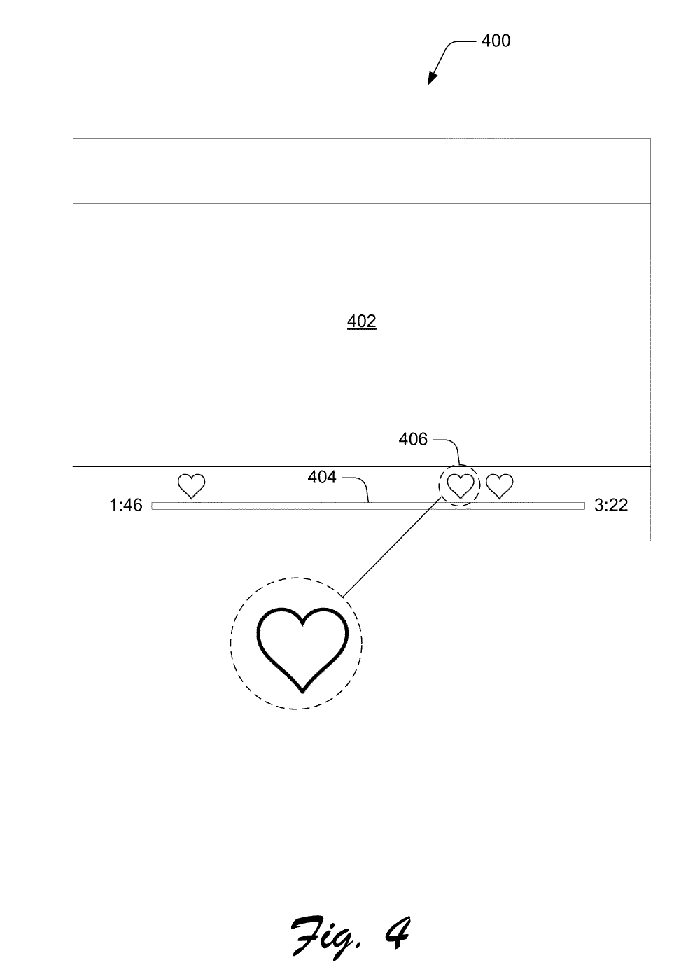

As noted above, various embodiments enable visual representations associated with one or more emotions to be associated with content, such as videos or photos. A visual representation serves as a reference point to a particular content segment and conveys an emotion associated with the content segment. In this sense, visual representations serve as ideograms or ideographs that can represent emotions such like, dislike, love, hate, and the like, associated with content. When such content is shared amongst various users, the visual representations convey emotion to those who consume the content. In social networking settings, the visual representations can serve to facilitate a viral quality to publish content. As an example, consider FIG. 4.

There, a user interface is shown generally at 400, in accordance with one or more embodiments. The user interface is part of an application that allows content to be consumed, such as a media playing application or a user interface provided by a social networking site. As such, a user interface portion 402 is provided in which content can be rendered for the user. Rendered content can include, by way of example and not limitation, photos, videos, and the like. In addition, in at least some embodiments, and particularly in those in which video is rendered in the user interface portion 402, a timeline 404 can be provided. The timeline represents individual points within a particular video. In the current example, the timeline is defined by a video starting point of 1:46 minutes and a video ending point of 3:22 minutes.

In this particular example three visual representations, an example of which is shown at 406, have been added to the video content at various times along timeline 404. The visual representation in this example comprises a heart shape which is shown enlarged to the left and below user interface 400. In this particular example, the visual representation serves both as a reference point to a particular video segment, as well as a mechanism by which emotion is conveyed. In this particular example, the heart shape conveys a “strong like” or “love” emotion.

It is to be appreciated and understood that any suitable type of visual representation can be utilized without departing from the spirit and scope of the claimed subject matter. Such visual representations can convey any suitable types of emotion. Further, different cultures around the world may have visual representations that convey emotion in a manner understood by members of the culture, but not necessarily understood by those who are not members of the culture. Accordingly, the visual representations may be culture-specific, country-specific, and the like, without departing from the spirit and scope of the claimed subject matter.

Having considered an example visual representation, consider now various ways in which visual representations can come to be associated with various types of content.

Visual Representations Provided by Content Producers

As noted above, visual representations can be created and associated with content by those who produce the content. This can occur contemporaneously during the content production process. Alternately or additionally, this can occur after the content is produced during, for example, a content editing phase.

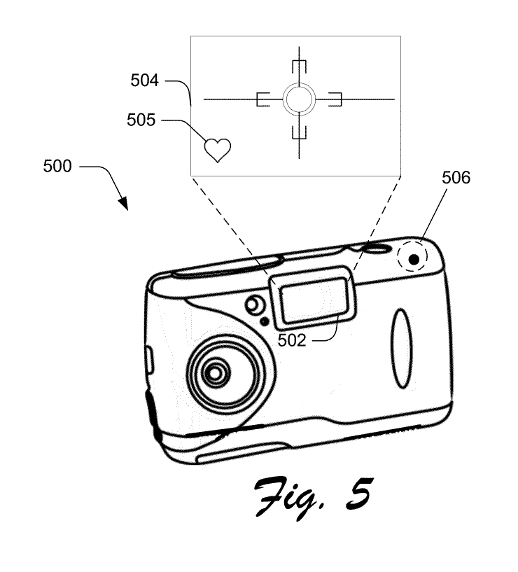

As an example, consider FIG. 5 which illustrates a camera generally at 500. The camera includes a viewfinder 502 which provides a display 504 that is superimposed over content that is captured by the camera. The display 504, in this particular example, includes a visual representation 505 in the lower left corner. A button 506 is provided on the camera. As a user uses the camera to capture photos and/or video, by pressing button 506, a visual representation can be associated with the captured photo at a corresponding point in captured video. As an example, consider a user who is in the process of recording their baby's first steps. The user may find that they have to record over a long period of time, perhaps 5 to 10 minutes, in order to capture their baby taking his or her first steps. At five minutes into the video, the user's baby takes his or her first step. At this point, the user can press button 506 in order for a visual representation to be inserted into the video. This can serve not only as a navigation point that can be used to navigate to that segment of the video, but also serves to convey an emotion associated with that content segment.

In addition, in at least some embodiments, when button 506 is pressed, visual representation 505 can change in its visual appearance to indicate to the user that the visual representation has been added to the image or video. The change in visual appearance can comprise any suitable change such as, by way of example and not limitation, blinking, changing colors, and the like.

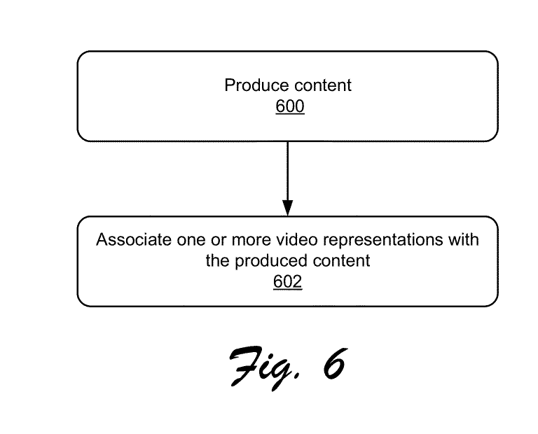

FIG. 6 is a flow diagram that describes steps in a method in accordance with one or more embodiments. The method can be implemented in connection with any suitable hardware, software, firmware, or combination thereof. In one or more embodiments, aspects of the method can be implemented by a suitably-configured emotion indicator module, such as emotion indicator module 107 described above.

Step 600 produces content by capturing the content with a camera. Any suitable type of content can be captured including, by way of example and not limitation, photos and/or videos. Step 602 associates one or more visual representations with the produced content. Any suitable type of visual representation can be utilized, examples of which are provided above. In at least one or more embodiments, visual representations are associated with the content during the time that the content is being captured. The visual representations can be associated with the content by, for example, being included in metadata that accompanies or otherwise forms part of the content. In the example just above, visual representations can be inserted while video content is being captured through the use of a suitably-configured user interface instrumentality on the camera. In addition, the metadata may identify a time range on either side of the content location with which the visual representation is to be associated. For example, when a visual representation is associated with content, the metadata may specify that one or two seconds on either side of the visual representation constitute the content segment that has the association with the visual representation.

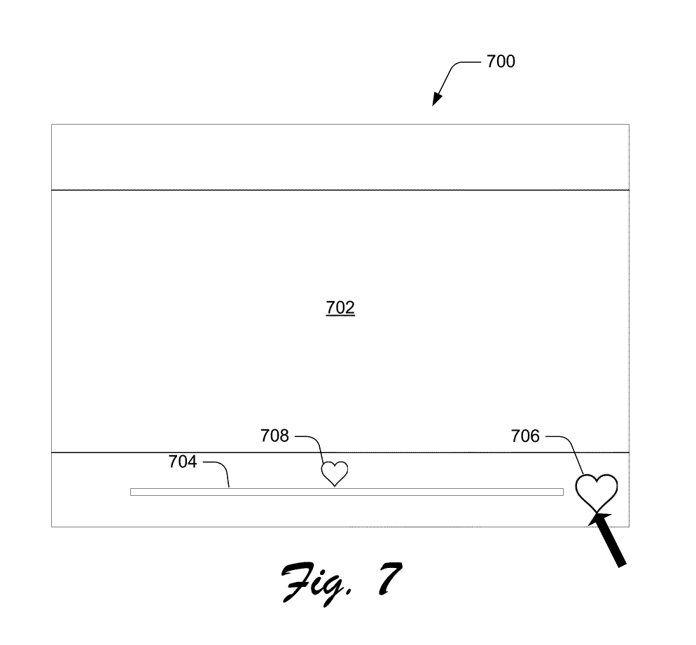

As noted above, visual representations can be provided after the content is captured during, for example, a content editing phase. During the content editing phase, the content producer can interact with their content to add visual representations. As an example, consider FIG. 7.

There, a user interface is shown, generally at 700, in accordance with one or more embodiments. The user interface is part of an application that allows content to be edited, such as a media playing application. As such, a user interface portion 702 is provided in which content can be rendered for the content producer. Rendered content can include, by way of example and not limitation, photos, videos, and the like. In addition, in at least some embodiments, and particularly those in which video is rendered in the user interface portion 702, a timeline 704 can be provided. The timeline represents individual points within a particular video.

In this particular example, a selectable user interface instrumentality 706 is provided and enables the content producer or editor to add visual representations to their content. In this particular example, as the content is rendered in user interface portion 702, the content producer can click on or otherwise select the user interface instrumentality 706 so that a visual representation 708 is added to the content. After editing their content, the content producer can share their content with friends and others through any suitable mechanism including, by way of example and not limitation, various social networking sites or services which enable content to be uploaded, peer-to-peer mechanisms, e-mail, and the like.

In yet other embodiments, visual representations can be created and associated with content by individuals other than content producers.

Visual Representations Provided by Content Consumers

In at least some embodiments, visual representations can be added by those who consume content. For example, an individual may receive a video from a friend by way of a social networking site, through peer-to-peer exchange or by email. When the individual consumes video, they can add visual representations to the video in much the same way as described above with respect to FIG. 7. That is, the individual's media-playing software can provide a suitable user interface with a user interface instrumentality to enable the user to add visual representations to content that they consume.

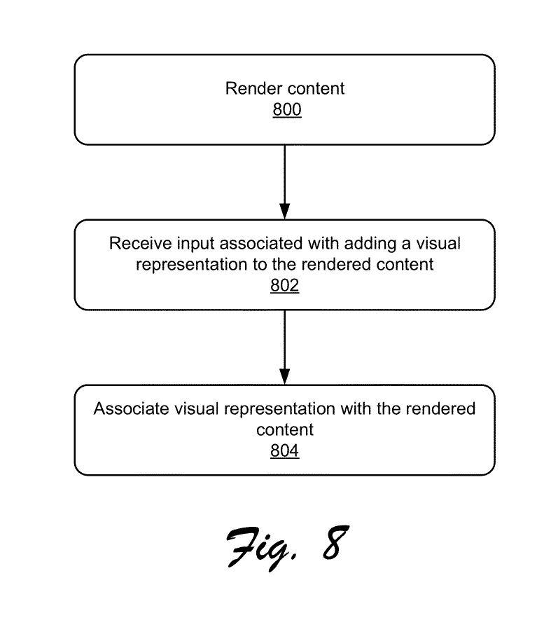

FIG. 8 is a flow diagram that describes steps in a method in accordance with one or more embodiments. The method can be implemented in connection with any suitable hardware, software, firmware, or combination thereof. In one or more embodiments, aspects of the method can be implemented by a suitably-configured emotion indicator module, such as emotion indicator module 107 described above.

Step 800 renders content that has been previously captured. This step can be performed in any suitable way. For example, the step can be performed by a suitably-configured media playing application. Any suitable content can be rendered including photos and/or videos. Step 802 receives an input associated with adding a visual representation to the rendered content. Any suitable input can be received. In at least some embodiments, the input can be received by way of a suitably-configured user interface instrumentality, examples of which are provided above. Responsive to receiving the input, step 804 associates a visual representation with the rendered content. This step can be performed in any suitable way using any suitable type of visual representation. The visual representations can be associated with the content by, for example, being included in metadata that accompanies or otherwise forms part of the content.

Having described how visual representations can be created and associated with content in various embodiments, consider now how visual representations can be utilized in accordance with various embodiments.

Generating Thumbnails Using Various Reference Points

Visual representations can be used in a variety of ways to enhance a user's content-consuming experience.

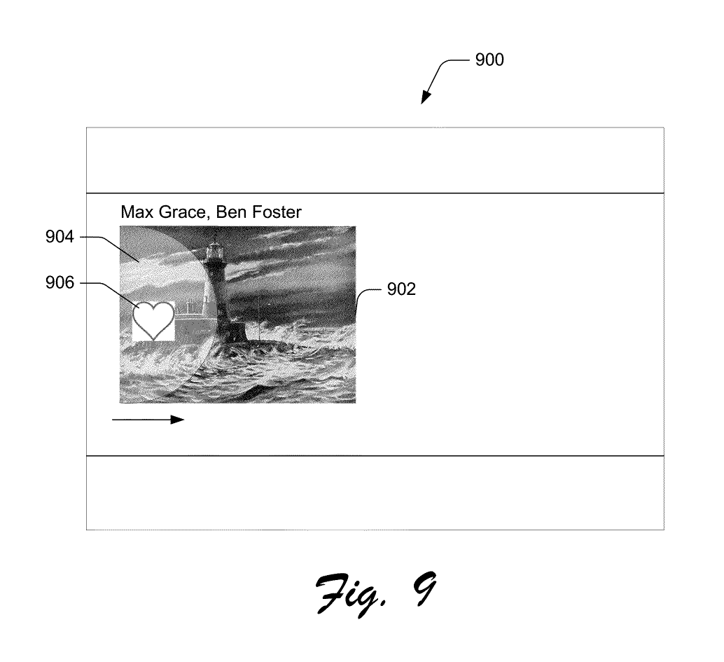

In one or more embodiments, thumbnail images can be generated using various reference points associated with visual representations. The thumbnail images can be used to advertise, in a sense, interesting parts of content to those with whom content is shared. As an example, consider FIG. 9.

There, a user interface in accordance with one or more embodiments is shown generally at 900. In this example, user interface 900 is associated with a software application that can be used to consume content, such as a media player application, a web browser, or a content sharing application such as a social networking application. Assume in this example that the user is Max Grace and that another user, Ben Foster, has added a visual representation to a particular video that has been uploaded to a content sharing service. In this instance, the content sharing service, or some other software entity, can create a thumbnail image 902 at or around the insertion point of the visual representation. Included with thumbnail image 902, an animation 904 in the form of a semicircle that slides in from the left of the thumbnail in the direction of the arrow, along with a visual representation 906 can be provided. This thumbnail image, as well as other thumbnail images, can then be shared with other users, such as Max Grace, to inform Max that Ben Foster has added a visual representation to a video. Max is then free to access and view the video and use the visual representation as a navigation instrumentality to navigate to the video segment that has been marked by Ben Foster.

In one or more embodiments, thumbnail images can be cycled through, for a particular video, to indicate the different segments that have had visual representations added to them by the same or different users. So, for example, if a particular video has had three visual representations added by three different users, three different corresponding thumbnail images can be presented along with the associated animation 904 and visual representation 906 to inform the user that the video has different visual representations associated with it. In this manner, the visual representations can be utilized to create a video summary of the content segments that have had visual representations added to them.

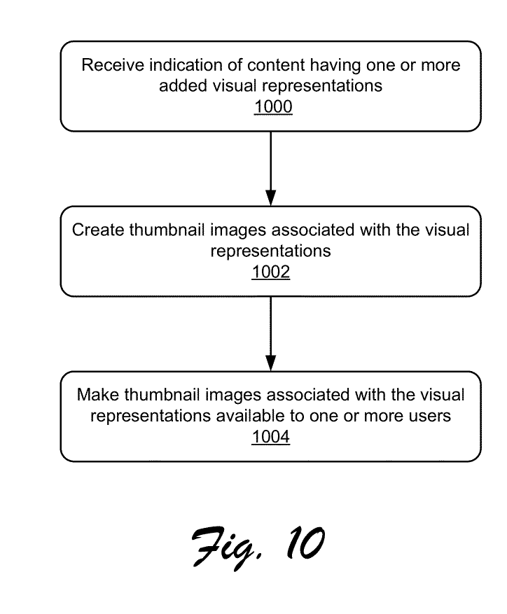

FIG. 10 is a flow diagram that describes steps in a method in accordance with one or more embodiments. The method can be implemented in connection with any suitable hardware, software, firmware, or combination thereof. In one or more embodiments, aspects of the method can be implemented by a suitably-configured emotion indicator module, such as emotion indicator module 107 described above. Aspects of the method about to be described can be performed by a suitably configured service such as a web service or so-called “cloud” service.

Step 1000 receives an indication of content having one or more added visual representations. This step can be performed in any suitable way. For example, a user may view a video that one of their friends uploaded to a social networking site. While viewing the video, the user may provide one or more visual representations at various video segments that they deem particularly interesting, as described in relation to FIGS. 7 and 8. When the visual representations are provided on the video, an indication that the visual representations have been added can be provided by software on the user's computing device to a service that hosts the content. The indication can include things such as the type of visual representation, location of the visual representation within the content, and the like. Step 1002 uses this indication to create thumbnail images associated with the visual representations. This step can be performed in any suitable way.

Step 1004 makes thumbnail images associated with the visual representations available to one or more users. The step can be performed in any suitable way. For example, in at least some embodiments, the thumbnail images can be made available to various users when, for example, the user is logged into an associated service, such as a social networking site. Alternately or additionally, the thumbnail images can be made available to one or more users using a push-type notification. Specifically, when the thumbnail image is created, a notification can be generated and sent to one or more users that indicate that a visual representation has been added to content.

Having been notified that visual representations have been added to one or more pieces of content, a recipient user can now take steps to access the content and view not only the content, but the various segments that have had visual representations added to them.

Viewing Visual Representations and Who has Provided them

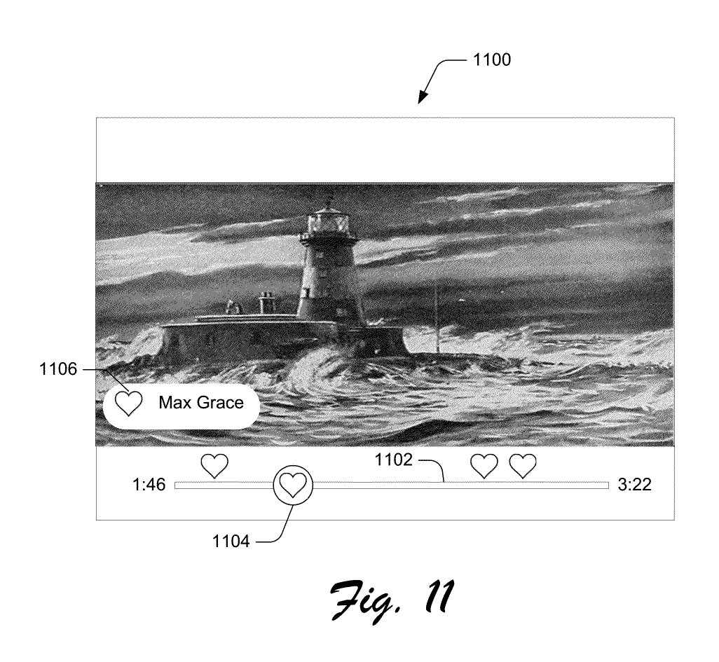

In one or more embodiments, when a video is played back, the visual representations can be viewed along with information associated with the visual representations. For example, such information can include the names of the individuals who provided the visual representations, and any other information provided by the individuals such as comments and the like. As an example, consider FIG. 11.

There, a user interface is shown generally at 1100 in accordance with one or more embodiments. The user interface can be associated with a software application that enables a user to consume video or other content that has been shared from other users. The user interface includes a timeline 1102 associated with the content that is being viewed which, in this case, constitutes a video. The timeline 1102 includes a number of different visual representations in the form of hearts. In this particular example, one of the hearts is highlighted at 1104. This location in the video corresponds to a location at which a visual representation was added. In addition, a notification 1106 is provided with the video to indicate who added the visual representation at that particular location. In this example, the heart represented at 1104 was added by Max Grace.

The visual representations can also be used as a navigation aid to navigate through the particular content that has been marked with a visual representation. Accordingly, by selecting one of the visual representations, a user can navigate the presentation to the location at which the visual presentation was provided.

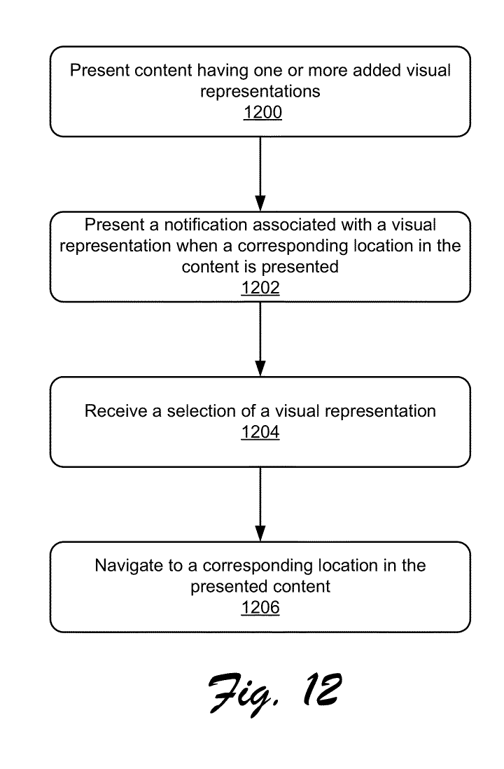

FIG. 12 is a flow diagram that describes steps in a method in accordance with one or more embodiments. The method can be implemented in connection with any suitable hardware, software, firmware, or combination thereof. In one or more embodiments, aspects of the method can be implemented by a suitably-configured emotion indicator module, such as emotion indicator module 107 described above.

Step 1200 presents content having one or more added visual representations. This step can be performed in any suitable way. For example, in the FIG. 11 example, this step is performed by presenting content in a suitably-configured user interface, along with the timeline along which visual representations are disposed. The visual representations in that example comprised hearts, but could comprise any suitable type of visual representation that serves to mark a location in the content and convey an emotion as described above. Step 1202 presents a notification associated with the visual representation when a corresponding location in the content is presented. Again, with reference to FIG. 11, when the content presentation reaches a location associated with visual representation 1104, a notification 1106 is presented that indicates who provided the visual representation. Alternately or additionally, the notification can provide other information including, by way of example and not limitation, comments and the like.

Step 1204 receives a selection of a visual representation. This step can be performed in any suitable way. For example, a user may click on or otherwise select, as through touch selection, a visual representation. Responsive to receiving the selection, step 1206 navigates to a corresponding location in the present content. For example, in the FIG. 11 example, if a user were to select the right-most visual representation, the displayed content would be navigated to that particular location.

Having considered an example method in accordance with one or more embodiments, consider now an auto summary feature and how visual representations can be utilized to promote an automatic content summary.

Auto Summary

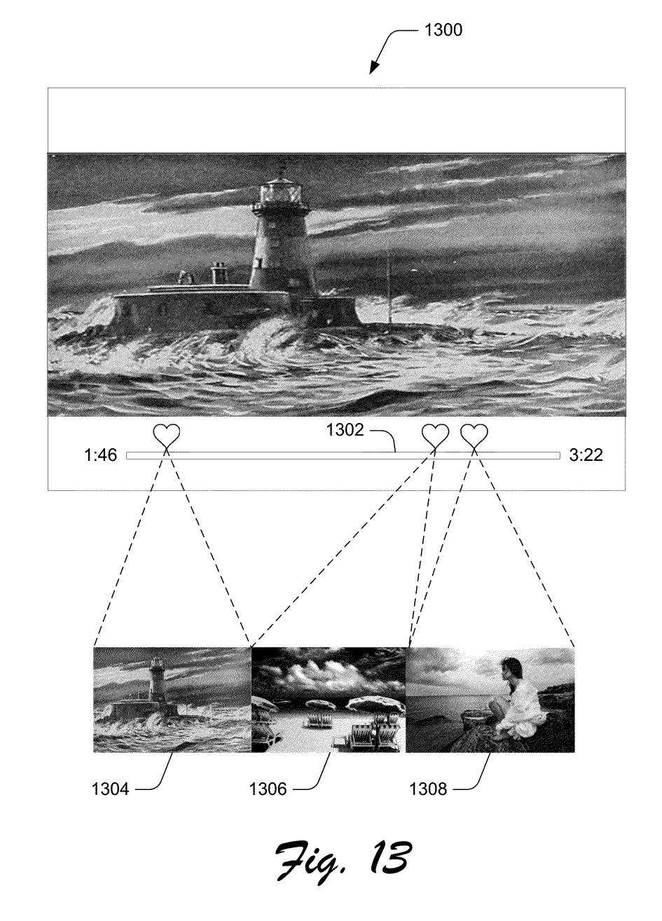

In one or more embodiments, the visual representations can be utilized to provide a summary of the captured content to be created. Specifically, excerpts of the content associated with each visual representation can be combined to provide a truncated presentation which can represent a summary of content segments that various users find interesting. This summary of interesting content segments can serve, in a sense, as a video preview of the content. As an example, consider FIG. 13.

There, a user interface in accordance with one or more embodiments is shown generally at 1300. The user interface includes video content that is presented, as well as a time line 1302 associated with the video content. Notice, in this example, that there are three visual representations in the form of hearts distributed along the timeline. Each of these visual representations is associated with a particular portion of the video content. In this embodiment, each portion of video content that corresponds to a visual representation is excerpted and combined into a separate video that contains three different video segments. In the illustration, three different video segments are represented at 1304, 1306, and 1308. When played back, the combined video segments represent a video summary or preview of the overall content that is being presented.

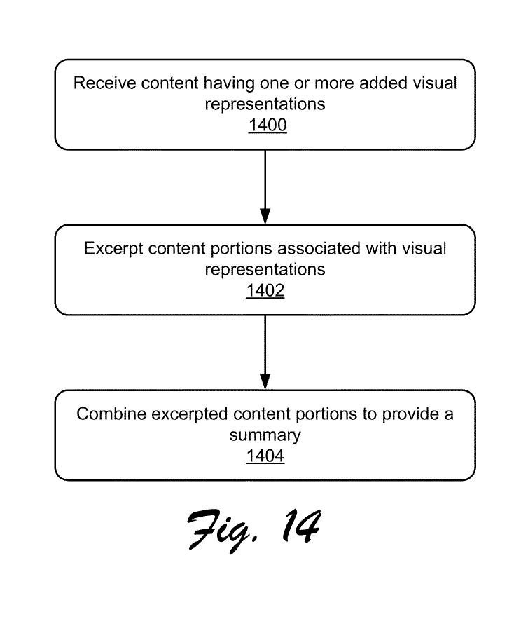

FIG. 14 is a flow diagram that describes steps in a method in accordance with one or more embodiments. The method can be implemented in connection with any suitable hardware, software, firmware, or combination thereof. In one or more embodiments, aspects of the method can be implemented by a suitably-configured emotion indicator module, such as emotion indicator module 107 described above.

Step 1400 receives content having one or more added visual representations. Examples of content having visual representations are provided above. Step 1402 excerpts content portions associated with each of the visual representations. For example, if the content comprises a video, this step can excerpt two or three seconds worth of video on either side of the visual representation. Once excerpted, step 1404 combines the excerpted content portions to provide a summary.

In at least some embodiments in which this process is performed by a service, such as a cloud service, the created content summary can be provided to various users as described above. Alternately or additionally, this process can be performed by a local client application which processes received content to provide the user with a content summary.

Having considered an auto summary embodiment, consider now an embodiment that provides so-called intelligent thumbnails.

Intelligent Thumbnails

In at least some embodiments, content can be processed to identify visual representations that appear within the content. Associated content portions corresponding to the visual representations can be excerpted and rendered as thumbnails to provide users with an idea of the content associated with each of the visual representations. The process for creating intelligent thumbnails is similar to that described with respect to FIG. 14.

Having considered example intelligent thumbnails in accordance with one or more embodiments, consider now aspects of animation that can take place to enhance the user's experience during placement of visual representations.

Animation

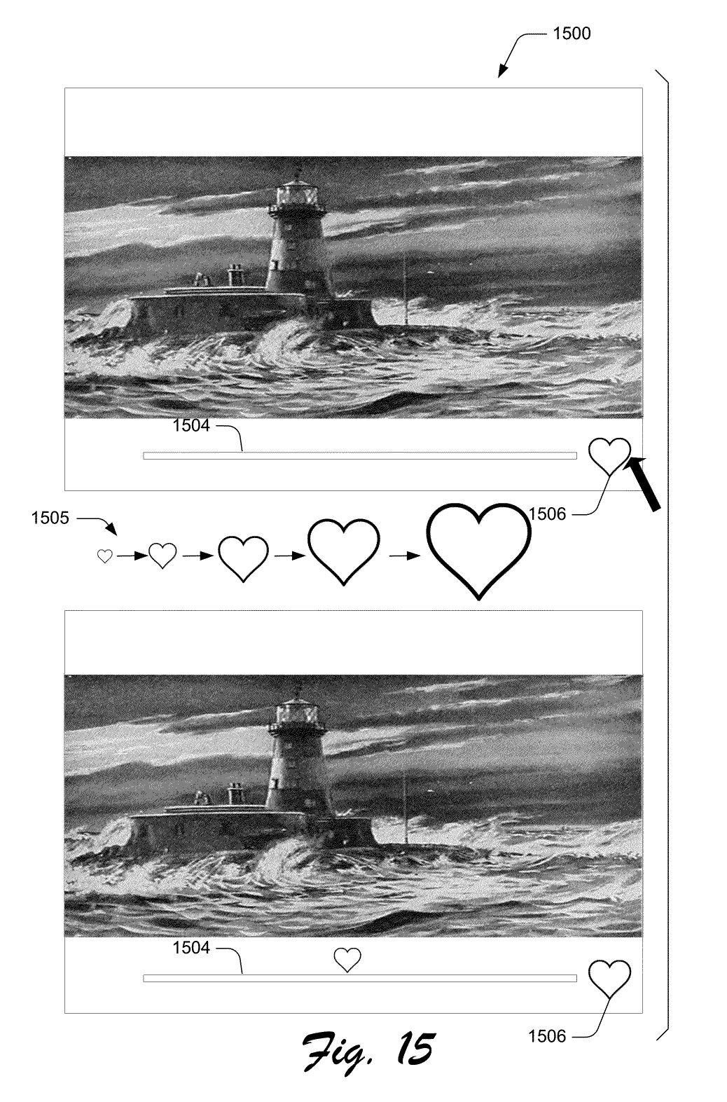

FIG. 15 illustrates an example user interface in accordance with one or more embodiments generally at 1500. In this particular example, the video content is being rendered in the user interface. A time line 1504 is provided and corresponds to locations within the video content. In addition, a user interface instrumentality 1506 is provided to enable a user to add visual representations to content that they review. In this example, when a user selects the user interface instrumentality 1506, a visual representation can be added. In at least some embodiments, addition of a visual representation can be preceded by an animation which is diagrammatically represented at 1505. In this instance a series of progressively larger visual representations are rendered atop the content that is being rendered in the user interface. In this example, the visual representation is a heart. When the user selects the user interface instrumentality 1506, a small heart appears on the content being rendered which is replaced by progressively larger and larger hearts until the largest heart disappears and reappears as a visual representation on the timeline. This is shown in the bottommost illustration.

Any suitable type of animation can be provided in connection with addition of a visual representation.

Having considered various embodiments, consider now an example device that can be utilized to implement one or more embodiments described above.

### Example Device

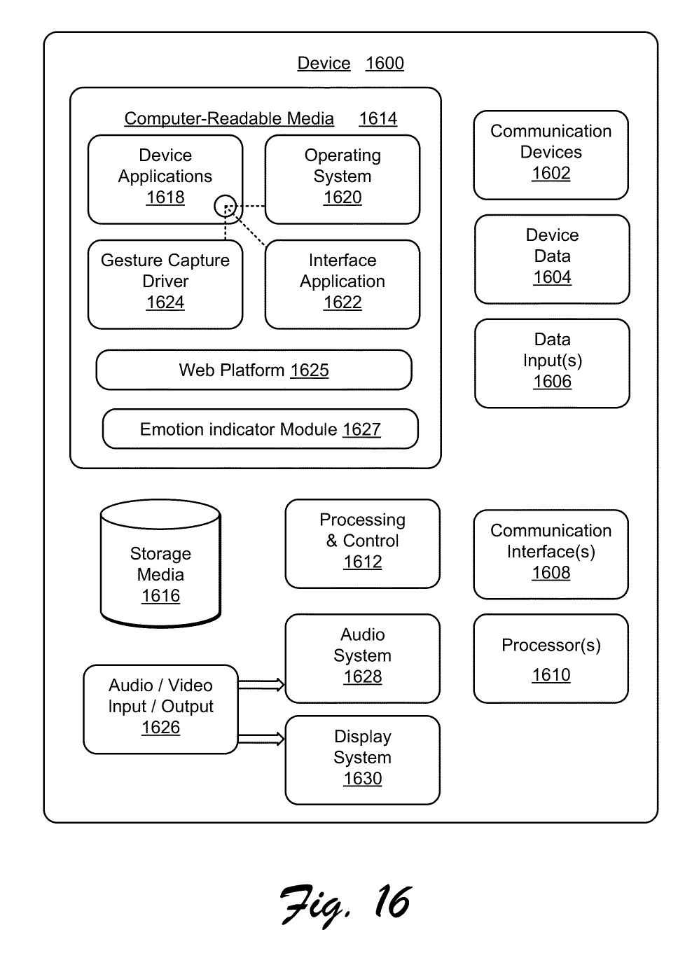

FIG. 16 illustrates various components of an example device 1600 that can be implemented as any type of computing device as described with reference to FIGS. 1 and 2 to implement embodiments of the techniques described herein. Device 1600 includes communication devices 1602 that enable wired and/or wireless communication of device data 1604 (e.g., received data, data that is being received, data scheduled for broadcast, data packets of the data, etc.). The device data 1604 or other device content can include configuration settings of the device, media content stored on the device, and/or information associated with a user of the device. Media content stored on device 1600 can include any type of audio, video, and/or image data. Device 1600 includes one or more data inputs 1606 via which any type of data, media content, and/or inputs can be received, such as user-selectable inputs, messages, music, television media content, recorded video content, and any other type of audio, video, and/or image data received from any content and/or data source.

Device 1600 also includes communication interfaces 1608 that can be implemented as any one or more of a serial and/or parallel interface, a wireless interface, any type of network interface, a modem, and as any other type of communication interface. The communication interfaces 1608 provide a connection and/or communication links between device 1600 and a communication network by which other electronic, computing, and communication devices communicate data with device 1600.

Device 1600 includes one or more processors 1610 (e.g., any of microprocessors, controllers, and the like) which process various computer-executable instructions to control the operation of device 1600 and to implement embodiments of the techniques described herein. Alternatively or in addition, device 1600 can be implemented with any one or combination of hardware, firmware, or fixed logic circuitry that is implemented in connection with processing and control circuits which are generally identified at 1612. Although not shown, device 1600 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1600 also includes computer-readable media 1614, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1600 can also include a mass storage media device 1616.

Computer-readable media 1614 provides data storage mechanisms to store the device data 1604, as well as various device applications 1618 and any other types of information and/or data related to operational aspects of device 1600. For example, an operating system 1620 can be maintained as a computer application with the computer-readable media 1614 and executed on processors 1610. The device applications 1618 can include a device manager (e.g., a control application, software application, signal processing and control module, code that is native to a particular device, a hardware abstraction layer for a particular device, etc.). The device applications 1618 also include any system components or modules to implement embodiments of the techniques described herein. In this example, the device applications 1618 include an interface application 1622 and a gesture capture driver 1624 that are shown as software modules and/or computer applications. The gesture capture driver 1624 is representative of software that is used to provide an interface with a device configured to capture a gesture, such as a touchscreen, track pad, camera, and so on. Alternatively or in addition, the interface application 1622 and the gesture capture driver 1624 can be implemented as hardware, software, firmware, or any combination thereof. Additionally, computer readable media 1614 can include a web platform 1625 and an emotion indicator module 1627 that functions as described above.

Device 1600 also includes an audio and/or video input-output system 1626 that provides audio data to an audio system 1628 and/or provides video data to a display system 1630. The audio system 1628 and/or the display system 1630 can include any devices that process, display, and/or otherwise render audio, video, and image data. Video signals and audio signals can be communicated from device 1600 to an audio device and/or to a display device via an RF (radio frequency) link, S-video link, composite video link, component video link, DVI (digital video interface), analog audio connection, or other similar communication link. In an embodiment, the audio system 1628 and/or the display system 1630 are implemented as external components to device 1600. Alternatively, the audio system 1628 and/or the display system 1630 are implemented as integrated components of example device 1600.

### CONCLUSION

Various embodiments enable visual representations associated with one or more emotions to be associated with content, such as videos or photos. A visual representation serves as a reference point to a particular content segment and conveys an emotion associated with the content segment. The visual representations can be created and associated with content by a number of different entities including, by way of example and not limitation, content producers and content consumers.

In at least some embodiments, the visual representations can be used to generate thumbnail images of the content, where a thumbnail image corresponds to a content segment with which a visual representation has been associated.

In yet further embodiments, the visual representations can be used to create a content summary. For example, content that has a number of different visual representations associated therewith, can be processed to produce a content summary that includes content segments associated with each of the visual representations.

Further, in at least some embodiments, the visual representations can include information such as who created the visual representation, as well as other information such as comments and the like. In addition, visual representations can be used to facilitate navigation to a particular content segment having an associated visual representation.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A computer-implemented method comprising:
capturing content with a camera; and
associating one or more visual representations with the content, the one or more visual representations serving as reference points to respective content segments and conveying an emotion associated with the content segments.

2. The method of claim 1, wherein said associating is performed during content capture.

3. The method of claim 1, wherein said associating is performed at a time other than during content capture.

4. The method of claim 1, wherein said associating is performed using metadata associated with the content.

5. The method of claim 1, wherein said capturing content comprises capturing video content.

6. The method of claim 1, wherein said associating is performed, at least in part, by receiving input through a user interface instrumentality on the camera.

7. The method of claim 1, wherein said associating is performed, at least in part, by receiving input through a user interface instrumentality.

8. The method of claim 1, wherein the one or more visual representations comprise hearts.

9. One or more computer readable storage media having instructions stored thereon that, responsive to execution by a computing device, cause the computing device to perform operations comprising:
rendering content that has been previously captured;
receiving an input associated with adding a visual representation to the rendered content, the visual representation serving as a reference point to a content segment and conveying an emotion associated with the content segment; and
responsive to receiving the input, associating the visual representation with the content.

10. The one or more computer readable storage media of claim 9, wherein the rendering content comprises rendering video content.

11. The one or more computer readable storage media of claim 9, wherein the visual representation comprises a heart.

12. The one or more computer readable storage media of claim 9, wherein the computer-readable instructions are configured to perform operations further comprising displaying one or more thumbnail images each of which being associated with a visual representation.

13. The one or more computer readable storage media of claim 9, wherein the computer-readable instructions are configured to perform operations further comprising displaying one or more thumbnail images each of which being associated with a visual representation, wherein said displaying comprises displaying an animation that includes a visual representation that conveys an emotion.

14. The one or more computer readable storage media of claim 9, wherein the visual representation is configured to enable navigation to an associated content segment.

15. The one or more computer readable storage media of claim 9, wherein the computer-readable instructions are configured to perform operations further comprising:
presenting different content having one or more added visual representations;
presenting a notification associated with a visual representation when a corresponding location in the different content is presented, the notification including a name of an individual who added the visual representation.

16. The one or more computer readable storage media of claim 9, wherein the computer-readable instructions are configured to perform operations further comprising:
receiving a selection of an individual visual representation; and
responsive to receiving the selection, navigating to a corresponding location in the content.

17. The one or more computer readable storage media of claim 9, wherein the computer-readable instructions are configured to perform operations further comprising: presenting a summary of the content, the summary comprising excerpted portions of the content each of which being associated with a different visual representation.

18. The one or more computer readable storage media of claim 9, wherein the computer-readable instructions are configured to perform operations further comprising: presenting a summary of the content, the summary comprising excerpted portions of the content each of which being associated with a different visual representation, wherein the summary comprises a video summary.

19. The one or more computer readable storage media of claim 9, wherein the computer-readable instructions are configured to perform operations further comprising: presenting a summary of the content, the summary comprising excerpted portions of the content each of which being associated with a different visual representation, wherein the summary comprises a thumbnail image summary.

20. A computing device comprising:
one or more processors;
one or more computer readable media;
an emotion indicator module embodied on the one or more computer readable media and, when executed by the one or more processors, is configured to perform operations comprising:
rendering content that has been previously captured;
receiving an input associated with adding a visual representation in the form of a heart to the rendered content, the visual representation serving as a reference point to a content segment and conveying an emotion associated with the content segment;
responsive to receiving the input, associating the visual representation with the content;
displaying one or more thumbnail images each of which being associated with a different visual representation;
presenting additional content having one or more added visual representations;
presenting a notification associated with a visual representation in the additional content when a corresponding location in the additional content is presented, the notification including a name of an individual who added the visual representation;
receiving a selection of an individual visual representation; and
responsive to receiving the selection, navigating to a corresponding content location.
